(19) United States
(12) Patent Application Publication
(10) Pub. No.: US 2022/0107245 A1
(43) Pub. Date: Apr. 7, 2022

(54) METHODS FOR PREPARING LIVE CELLS FOR ANALYSIS AND DETERMINING LOCALIZATION OF MEMBRANE-BOUND PROTEINS

(71) Applicant: Purdue Research Foundation, West Lafayette, IN (US)

(72) Inventors: Seema Mattoo, West Lafayette, IN (US); Ranjan Sengupta, West Lafayette, IN (US); Michael Poderycki, West Lafayette, IN (US); Elaine Marie Mihelc, Philadelphia, PA (US); Robert Virgil Stahelin, West Lafayette, IN (US)

(21) Appl. No.: 17/381,149

(22) Filed: Jul. 20, 2021

Related U.S. Application Data
(60) Provisional application No. 63/081,105, filed on Sep. 21, 2020.

(51) Int. Cl. G01N 1/30; G01N 1/42; G01N 23/046; G01N 23/06

(52) U.S. Cl. CPC G01N 1/30; G01N 1/42; G01N 23/046; G01N 2223/40; G01N 2001/302; G01N 2001/305; G01N 2223/04; G01N 23/06

(57) ABSTRACT

Methods of preparing live cells for analysis, including methods that may be used with electron microscopy (EM) for localization of membrane proteins to achieve reduced morphological damage to cellular membranes and membrane-bound organelles. Such a method involves performing a chemical fixation process on a cellular sample comprising live cells, and then performing a cryofixation process with extended osmication during freeze substitution on the cellular sample.

### CROSS-REFERENCE TO RELATED APPLICATIONS

This application claims the benefit of U.S. Provisional Application No. 63/081,105, filed Sep. 21, 2020, the contents of which are incorporated herein by reference.

### STATEMENT REGARDING FEDERALLY SPONSORED RESEARCH

This invention was made with government support under Contract Nos. AI081077 and GM100092 awarded by the National Institute of Health. The government has certain rights in the invention.

### SEQUENCE LISTING

The instant application contains a Sequence Listing which has been submitted electronically in ASCII format and is hereby incorporated by reference in its entirety. Said ASCII copy, created on Dec. 17, 2021, is named C1-6182_SL.txt and is 1,984 bytes in size.

### BACKGROUND OF THE INVENTION

The present invention generally relates to methods for preparing live cells for analysis. The invention particularly relates to methods that combine chemical fixation processes with cryofixation processes for localization of membrane proteins.

Localization of membrane proteins via electron microscopy (EM) at high resolution is dependent on robust detection technology and on sample preparation methods that confer superior ultrastructural preservation of membranes. Unfortunately, current methods of localization of membrane-bound proteins at EM resolutions are less than optimal. Immunoelectron microscopy (IEM) to detect either an endogenous or epitope-tagged overexpressed protein using antigenspecific antibodies requires a permeabilization step that also causes degradation of cellular membranes and distortion of membranebound compartments (De Mey et al., 1981; Schnell et al., 2012). An alternative is to fuse enzymatic tags directly to the protein of interest in a transfection experiment, so as to avoid the necessity for introducing an antibody. A number of these enzymatic tags have been described, e.g. metallothioneine (METTEM), resorufin arsenical hairpin (ReAsH), miniSOG, horseradish peroxidase (HRP) and more recently, engineered ascorbate peroxidases (APEX and APEX2) (Hoffmann et al., 2010; Lam et al., 2015; Martell et al., 2012; Mercogliano and DeRoiser, 2007; Porstmann et al., 1985; Shu et al., 2011). While each of these technologies faces its own set of limitations when employed in conjunction with EM, the APEX2 tag, which has been used with success on mitochondrial and ER proteins, is a promising option (Martell et al., 2017). APEX2 is a monomeric 28 kDa soyabean ascorbate peroxidase that withstands strong EM fixation (Lam et al., 2015). Additionally, it is sensitive, generally straightforward in its application and, unlike horseradish peroxidase, is active in both the cytosolic and lumenal compartments (Hopkins et al., 2000; Lam et al., 2015; Martell et al., 2017). Nevertheless, the morphological damage to cellular membranes and membrane-bound organelles that occurs during conventional aldehyde fixation and alcohol dehydration protocols, even without the permeabilization required for antibodies, continues to be an impediment to obtaining optimal preservation of the subcellular architecture.

In contrast, cryofixation or high-pressure freezing (HPF) is a method for obtaining vitreous preparations of live cells and tissues up to 200 μm in thickness with minimal ice crystal formation, thus immobilizing macromolecular assemblies in their near-native state (Chan et al., 1993; Mcdonald, 1999; Zechmann et al., 2007; Studer et al., 2008). This method has become a mainstay for preparing samples for electron tomography, which employs thicker sections (McDonald and Auer, 2006). Further, HPF has been adapted in combination with freeze substitution (FS) methods, which entail organic substitution of water with acetone at low temperature, to generate plastic-embedded samples for conventional EM. However, HPF-FS has not been extensively used with protein localization methods that require chemical fixation of cells (Tsang et al., 2018). Current HPF-FS techniques may not be compatible with common staining processes.

In view of the above, it can be appreciated that there are certain problems, shortcomings or disadvantages associated with localization of membrane proteins via EM, and that it would be desirable if systems and methods were available that were capable of at least partly overcoming or avoiding the morphological damage to cellular membranes and membrane-bound organelles noted above.

### BRIEF DESCRIPTION OF THE INVENTION

The present invention provides methods capable of performing localization of membrane proteins with reduced morphological damage to cellular membranes and membrane-bound organelles relative to conventional techniques.

According to one aspect of the invention, a method is provided for preparing live cells for analysis that includes performing a chemical fixation process on a cellular sample comprising the live cells, and then performing a cryofixation process with extended osmication during freeze substitution on the cellular sample.

According to another aspect of the invention, a method is provided for determining localization of membrane-bound proteins within a preserved membrane architecture within a cellular sample. The method includes performing a glutaraldehyde fixation process on a cellular sample comprising the live cells, performing a cryofixation process with extended osmication during freeze substitution on the cellular sample, performing a staining process on the cellular sample, and analyzing the cell sample with electron tomography.

Technical effects of the methods described above preferably include the capability of fixing the morphology of live cell samples for analysis with little to no damage to cellular membranes and membrane-bound organelles within the sample.

Other aspects and advantages of this invention will be appreciated from the following detailed description.

### BRIEF DESCRIPTION OF THE DRAWINGS

FIGS. 1A through 1I include results from a combination of chemical fixation and cryofixation which exhibited superior ultrastructure preservation and membrane staining over traditional methods in HEK-293T cells. Specifically, FIGS. 1A through 1I show HEK-293T cells prepared by conventional glutaraldehyde fixation and dehydration methods (1A-1C), glutaraldehyde followed by cryofixation (1D-1F) or cryofixation alone (1G-1I) examined by thin-section EM. FIGS. 1B, 1E, and 1H represent magnified views from boxed regions of FIGS. 1A, 1D, and 1G, respectively. FIGS. 1C, 1F, and 1I represent magnified views of the boxed regions from FIGS. 1B, 1E, and 1H, respectively, and highlight the preservation of the nuclear membrane in each case (yellow arrowheads). The nuclear membrane appears smooth and uncompromised in samples prepared by glutaraldehyde treatment and cryofixation (Glut+HPF+FS) or cryofixation alone (Live+HPF+FS), but is ruffled and irregular in samples prepared by conventional means (Glut+Alcohol).

FIGS. 1J through 1O show BHK cells with ultrastructural preservation prepared by a combined (Glut+HPF+FS) method (FIGS. 1M-1O) which was comparable to that in cryofixed (Live+HPF+FS) cells (FIGS. 1J-1L), as illustrated by the presence of intact mitochondria (yellow arrowheads, FIGS. 1K and 1N), intact endoplasmic reticulum (ER; blue arrowheads, FIGS. 1K and 1N), and absence of ruffled nuclear membranes (red arrowheads, FIGS. 1L and 1O). FIGS. 1K and 1L are magnified views of the respective yellow and red boxes in FIG. 1J. FIG. 1O is a magnified view of FIG. 1N, which is a magnified view of the region delineated by the white box in FIG. 1M. Glut, glutaraldehyde; HPF, high-pressure freezing; FS, freeze substitution; N, nucleus.

FIGS. 2A and 2B include images representative of organized smooth ER (OSER) as a system for evaluating membrane preservation and staining specificity. FIG. 2A includes a flowchart describing cryoAPEX. FIG. 2B includes a schematic of APEXtagged ERM expressed on the cytosolic face of the ER membrane.

FIGS. 3A through 3I include images indicating the reorganized ER morphology in chemically fixed, DAB reacted ERM-APEX2-expressing cells that were processed via traditional chemical fixation and alcohol dehydration (FIGS. 3A-3C) or by cryoAPEX (FIGS. 3D-3F) compared to ERM-APEX2 expressing cells that were cryofixed live and without the DAB reaction (FIGS. 3G-3I). The live cryofixed cells (FIGS. 3G-3I) represent the best attainable ultrastructural preservation and serve here as the metric for evaluating membrane preservation obtained via the two APEX-based detection protocols (FIGS. 3A-3F). The high specificity of staining obtained by cryoAPEX is exemplified in the images in FIGS. 3J-3L. Here, thin-section images of cells expressing ERM-APEX2 processed by cryoAPEX show preferential staining of the reorganized ER (FIG. 3J, orange asterisks) and the outer mitochondrial membrane (red asterisks in FIG. 3J and orange arrowheads in FIGS. 3k and 3L, respectively) but not of the mitochondrial cristae (FIG. 3K, red arrowheads).

FIGS. 4A through 4F represent post-staining with heavy metals which improved definition of preferentially stained membranes. Post-staining of thin sections with heavy metals using uranyl acetate and Sato's lead solution following cryoAPEX provided additional contrast, thereby improving resolution. Shown are thin sections of the same cell imaged in FIG. 3D before (FIGS. 4A, 4C, and 4E) and after (FIGS. 4B, 4D, and 4F) post-staining. Comparison of FIGS. 4E and 4F clearly shows improved definition and the resolution of membranes at high magnifications in post-stained samples (FIG. 4F). UA, uranyl acetate.

FIGS. 5A through 5G represent experimental data that indicated that HYPE localizes to the lumenal face of the ER membrane as periodic foci. FIG. 5A shows an image of a thin section of HEK-293T cells expressing HYPE-APEX2 and processed by cryoAPEX that reveals staining of the ER tubules in a well-preserved (dense) cytoplasmic background. FIGS. 5B and 5C are higher magnification images of a small section of the peripheral ER (demarcated by yellow box in FIG. 5A and shown in FIG. 5B, with further magnification of red box in FIG. 5B shown in FIG. 5C) that exhibit periodic foci of APEX2-generated density (FIG. 5B, red box and FIG. 5C, white arrowheads showing periodicity between the HYPE foci). FIG. 5D represents center-to-center density measurements showing the distance (in nm, blue lines) between the HYPE-specific foci (yellow circles) in FIG. 5C. FIG. 5E represents untransfected control HEK-293T cells processed in an identical manner show the lack of APEX2-generated density within the ER lumen. FIGS. 5F and 5G are higher magnification images of a small section of FIG. 5E (demarcated by yellow box and shown in FIG. 5F, with further magnification of red box in FIG. 5F shown in FIG. 5G) clearly shows the lack of density on the lumenal face. Additionally, density corresponding to ribosomes on the cytoplasmic face of the ER membrane is evident (FIG. 5G, white arrowheads). Thus, HYPE was detected only along the lumenal face of the ER membrane and never on the cytosolic face.

FIGS. 6A through 6F represent assessments of localization of HYPE in subcellular compartments other than the ER. FIG. 6A represents localization of HYPE to the nuclear envelope (NE). Images of thin sections from cells transfected with HYPE-APEX2 and processed by cryoAPEX show HYPE-specific density within the perinuclear space of the nuclear envelope (FIGS. 6A-6C). At higher magnification, this staining shows a pattern similar to that seen along the lumenal face of the ER membrane (FIG. 6C; compare red and yellow arrowheads within the NE and the ER, respectively). The same untransfected cells as used in FIG. 5E processed in this manner exhibited no membrane-associated staining within the perinuclear space of the nuclear envelope (FIGS. 6D-6F and white arrowheads in FIG. 6F).

FIGS. 7A through 7C represent experimental data that indicated that HYPE does not localize to the mitochondria. Cells transfected with HYPE-APEX2 were processed by cryoAPEX in the presence of osmium tetroxide but without addition of uranyl acetate or tannic acid. Thin sections of these cells showed a distinct lack of mitochondrial membrane staining, making it difficult to visualize mitochondria at low magnifications (red asterisks in FIG. 7A). Magnified images of well-preserved ER-mitochondrial junctions (MAMS; demarcated by red box in a with further magnification of red box area shown in FIG. 7B) clearly show ER tubules in close contact with two adjacent mitochondria (FIG. 7B). A further magnified image of the MAMS shows the HYPE-APEX2 staining of the ER but no apparent staining within the inner or outer mitochondrial membranes (FIG. 7B, yellow box; and FIG. 7C, magnified image of the area within this yellow box). The periodic distribution of HYPE is retained even at the MAMS (FIG. 7C, white arrowheads). MITO, mitochondrion; IMM, inner mitochondrial membrane; OMNI, outer mitochondrial membrane; MAMS, mitochondria-associated membranes.

FIGS. 8A through 8C represent experimental data that indicated that HYPE does not localize to the plasma membrane (PM). Images of a cell expressing HYPE-APEX2 revealed absence of plasma membrane staining (FIG. 8A). Images of ER-PM junctions at high magnifications show well-preserved junctions where the ER makes extended contacts with the plasma membrane (red box in FIG. 8A; yellow box in FIG. 8B; white bar in FIG. 8C). FIG. 8B shows higher magnification of red box area in FIG. 8A, FIG. 8C shows higher magnification of yellow box area in FIG. 8B. Staining was contained within the cortical ER tubules with no apparent staining of the plasma membrane (FIG. 8C, black arrowheads).

FIGS. 9A through 9D represent experimental data that indicated that HYPE does not enter the secretory pathway. To assess whether HYPE enters the secretory pathway, the Golgi apparatus was imaged (FIGS. 9A-9D). Images from thin sections of HYPE-APEX2-transfected cells showed an area where ER tubules are interspersed within Golgi stacks (FIG. 9A, region within yellow box). Higher magnification of this region (FIG. 9B shows higher magnification of yellow box area in FIG. 9A, FIG. 9C shows higher magnification of red box area in FIG. 9B) shows the typical stacked morphology of the Golgi apparatus devoid of any osmicated DAB density within its lumen. Further magnification of a well-preserved ER-Golgi junction (FIG. 9D) shows a region of extensive contact between the two organelles where the DAB density was restricted to the ER lumen and shows no apparent staining of the Golgi apparatus (FIG. 9B, area within red box; red arrowheads in FIG. 9C and FIG. 9D indicate the ER-Golgi junction).

FIGS. 10A through 10I represent experimental data indicating that superior ultrastructural preservation enables the tracking of HYPE's subcellular localization via serial sectioning. To demonstrate the consistency of the membrane ultrastructure preservation obtained by cryoAPEX, cells expressing HYPE-APEX2 were serially sectioned and a specific area (FIG. 10A, yellow box) was imaged. Multiple ribbons containing between 10 and 20 serial sections of 90 nm thickness were collected, screened and imaged. Representative images of eight serial sections showing ER localization of HYPE are presented (FIGS. 10B-10I). Sections exhibit a dense well-preserved cytoplasm with undisrupted membrane ultrastructure of organelles such as mitochondria and Golgi complex in close proximity to the ER tubules containing HYPE-APEX2 density. Thus, HYPE localization can be followed through the volume of the cell without loss of contextual information. Scale bars: 5 μm (A); 8 μm (magnifications 1-8).

FIGS. 11A through 11C include images of EM tomographic reconstruction of the ER exhibiting HYPE-APEX2 density. Tilt-series from HEK-293T cells expressing HYPE-APEX2 and processed by cryoAPEX were collected for 3D reconstruction of HYPE-specific density. FIG. 11A is an image of the whole HYPE-APEX2-expressing cell showing an area containing ER tubules from where the tilt-series was collected (FIG. 11A and magnified red box). FIG. 11B shows the reconstructed tomogram of HYPE density within the ER lumen. FIG. 11C shows the reconstructed tomogram of the thresholded HYPE density (in maroon).

FIGS. 12A through 12C represent a view of a 3D model of the ER membrane (blue) and the HYPE density within (gold) of FIGS. 11A-11C generated and visualized with the IMOD ‘Isosurface’ tool (FIGS. 12A-12C).

FIGS. 13A through 13D include snapshots of a segment of the ER from the model of FIGS. 12A-12C showing the HYPE-APEX2 density (gold) modeled within the lumen of the ER membrane (blue) visualized from the top of the indicated clipping plane (FIGS. 13A-13C). Red arrowheads in FIG. 13B show magnified images of different regions within this segment show HYPE's periodic density pattern along the lumenal walls. Red arrowheads in FIG. 13C show another view exposing the full face of the density (gold) using visualization tools that make the membrane transparent. This pattern of HYPE-specific density is more apparent when the clipping plane is moved downward in the z-direction, progressively shaving through the depths of the different layers (FIG. 13D, slices i-xi), and is most apparent when visualized in the thinnest slice (slice xi).

FIG. 14 represents a clipping plane that moves in a head-to-tail direction and shows HYPE's density pattern on the ER membrane from a front-on perspective (slices 1-8).

FIGS. 15A through 15I include experimental data of a combination of chemical fixation and cryofixation process that exhibited superior ultrastructure preservation and membrane staining over traditional methods in HEK-293T cells. The cells were prepared by conventional glutaraldehyde fixation and dehydration methods (FIGS. 15A, 15B, and 15G), glutaraldehyde followed by cryofixation (FIGS. 15C, 15D, and 15H), or cryofixation alone (FIGS. 15E, 15F, and 15I) and were examined by thin-section EM. FIGS. 15G, 15H, and 15I represent magnified views from panels 15B, 15D, and 15F, respectively. Cells prepared by glutaraldehyde/cryofixation (Glut+HPF+FS) display dense homogenous staining of the cytosol that resembles that seen in cells preserved by cryofixation (HPF+FS), while cells prepared by conventional means (Glut+Alcohol) do not. Glut=glutaraldehyde. HPF=high pressure freezing. FS=freeze substitution.

FIGS. 16A through 16H include images showing a comparison of OSER membrane preservation using traditional chemical fixation versus cryoAPEX. The reorganized ER morphology in chemically fixed, DAB reacted ERM-APEX2 expressing HEK293 cells that were processed via traditional chemical fixation/alcohol dehydration (FIGS. 16A-16D) or by cryoAPEX (FIGS. 16E-16H) was compared following post staining with uranyl acetate and Sato's lead solution. The evenly-spaced parallel lamellar stacking of the ER derived membranes obtained by cryoAPEX (exemplified in FIGS. 16G and 16H), as opposed to the ruffled membranes obtained by traditional methods (FIGS. 16C and 16D), highlights the superior membrane preservation obtained by cryoAPEX.

FIGS. 17A through 17C represent organellar controls showing specificity of the signal obtained from APEX2-tagged proteins. APEX2-tagged protein constructs designed to localize to the mitochondrial matrix (mito-V5-APEX2; shown in FIG. 17A), or the golgi lumen (α-mannII-APEX2; shown in FIG. 17B), or the plasma membrane (CAAX-APEX2; shown in FIG. 17C) were transiently expressed in HEK293 cells and the samples processed by cryoAPEX. Each construct yielded organelle specific densities. Magnified views of two sections (yellow or red boxes) from the cells expressing α-mannIIAPEX2 (FIG. 17B) or CAAX-APEX2 (FIG. 17C) are shown. The red and white boxes in FIG. 17B further indicate the presence of organelles like the mitochondria and ER that can be visualized even in the presence of a golgi-specific DAB density associated with α-mannII-APEX2; however, these mitochondria and ER membranes do not display DAB staining, highlighting that we do not observe mislocalized or artefactual signals.

FIGS. 18A and 18B represent localization of HYPE using the traditional chemical fixation/dehydration method. FIG. 18A is an image of a thin section of a cell expressing HYPE-APEX2 shows specific staining of the cortical ER and the nuclear envelope (red arrows). FIG. 18B is at a higher magnification, periodic HYPE-specific foci were apparent within stretches of the ER (yellow box and white arrow heads in the inset), despite extensive membrane disruption, indicated by red arrows. NE=nuclear envelope.

FIGS. 19A through 19I include experimental data that indicated that superior ultrastructural preservation enables the tracking of ERM's subcellular localization via serial sectioning. To demonstrate the consistency of the membrane ultrastructure preservation obtained by cryoAPEX, cells expressing ERM-APEX2 were serially sectioned and a specific area (FIG. 19A, yellow box) was imaged. Multiple such ribbons containing between 10 and 20 serial sections of 90 nm thickness were collected, screened and imaged. Representative images of 8 serial sections showing ER localization of ERM are presented (FIGS. 19B-19I). Sections exhibit well-preserved OSERs. Thus, ERM localization and associated ER morphology changes can be followed throughout the volume of the cell without loss of contextual information.

FIG. 20 includes a Table S1 showing a sequence listing for α-MannII-APEX2. FIG. 20 discloses SEQ ID NO: 1.

### DETAILED DESCRIPTION OF THE INVENTION

The intended purpose of the following detailed description of the invention and the phraseology and terminology employed therein is to describe what is shown in the drawings, which include the depiction of one or more nonlimiting embodiments of the invention, and to describe certain but not all aspects of what is depicted in the drawings, including the embodiment(s) depicted in the drawings. The following detailed description also describes certain investigations relating to the embodiment(s) depicted in the drawings, and identifies certain but not all alternatives of the embodiment(s) depicted in the drawings. Therefore, the appended claims, and not the detailed description, are intended to particularly point out subject matter regarded as the invention, including certain but not necessarily all of the aspects and alternatives described in the detailed description.

Disclosed herein are methods for preparing live cells or cellular samples for analysis. The methods include a hybrid approach that combines chemical fixation processes and cryofixation processes. Such methods may be used in combination with staining processes to allow precise localization of membrane proteins in the context of a well-preserved subcellular membrane architecture. Notably, these methods are compatible with electron tomography (EM) and may be used to produce three-dimensional (3D) contextual maps of cellular samples. The methods are broadly applicable to membrane proteins such as luminal and cytosol-facing membrane proteins. Advantageously, the methods may be used to analyze and localize cells grown in monolayers. An exemplary but nonlimiting embodiment includes a method referred to herein as cryoAPEX, which combines glutaraldehyde chemical fixation and high-pressure freezing of cells with peroxidase tagging (APEX). CryoAPEX may include staining with tannic acid and/or uranyl acetate and counter-staining with a lead solution. Optionally, cellular samples may be reacted with diaminobenzadine (DAB). Preferably, the methods do not include certain process steps performed in conventional techniques that cause damage or degradation to the cellular sample, such as but not limited to a dehydration step performed prior to freezing.

Nonlimiting embodiments of the invention will now be described in reference to experimental investigations leading up to the invention.

To evaluate cryoAPEX, an EM tomography-compatible detection method was utilized to visualize the human FIC (filamentation induced by cAMP) protein, HYPE (also known as FICD). FIC proteins are a recently characterized class of enzymes that predominantly utilize ATP to attach AMP (adenosine monophosphate) to their protein targets (Casey and Orth, 2018; Truttmann et al., 2017; Worby et al., 2009). This post-translational modification is called adenylylation or AMPylation. The first FIC proteins, VopS and IbpA, were described in the pathogenic bacteria Vibrio parahemolyticus and Histophilus somni, respectively, where they serve as secreted bacterial effectors that induce toxicity in host cells by inactivating small GTPases through AMPylation (Mattoo et al., 2011; Worby et al., 2009; Xiao et al., 2010; Yarbrough et al., 2009; Zekarias et al., 2010). FIC proteins have also been implicated in bacterial cell division and persister cell formation, protein translation, cellular trafficking and neurodegeneration (Garcia-Pino et al., 2014; Harms et al., 2015; Mukherjee et al., 2011; Truttmann et al., 2018).

HYPE (huntingtin yeast interacting protein E) or FICD is the sole FIC protein encoded by the human genome (Faber et al., 1998; Sanyal et al., 2015). In humans, HYPE is expressed ubiquitously, albeit at very low levels. It is a single-pass type II membrane protein that localizes to the lumenal surface of the endoplasmic reticulum (ER) (Sanyal et al., 2015; Worby et al., 2009). HYPE plays a critical role in regulating ER homeostasis by reversibly AMPylating the Hsp70 chaperone, BiP (also known as HSPA5) (Ham et al., 2014; Sanyal et al., 2015; Preissler et al., 2015, 2017a,b). Biochemical and proteomic screens have identified additional AMPylation targets of HYPE and its orthologs, which include cytosolic chaperones, cytoskeletal proteins, transcriptional and translational regulators, and histones (Broncel et al., 2016; Truttmann et al., 2016, 2017). These data suggest that a fraction of HYPE could reside outside the ER, for example, in the nucleus or cytoplasm. Indeed, a small fraction of the HYPE homolog in Caenorhabditis elegans, FIC-1, has been shown to localize to the cytosol and AMPylate cytosolic c and Hsp40 proteins (Truttmann et al., 2017).

The low levels of HYPE expression in human cells combined with the resolution limitations of conventional immunofluorescence microscopy make obtaining definitive localization data difficult. CryoAPEX circumvents these limitations by using an electron microscopy approach. To visualize HYPE in cells, a technique was developed that preserves membrane ultrastructure and is compatible with transmission EM tomography methods to identify specific distribution of HYPE in three-dimensional (3D) space. HYPE was visualized by genetically tagging it with APEX2. The APEX2 tag catalyzes a peroxide-based reaction that converts diaminobenzadine (DAB) into a low-diffusing precipitate that deposits at the site of the target protein (Lam et al., 2015). In an analysis of HYPE leading to certain aspects of the present invention, a peptide, designated endoplasmic reticulum membrane (ERM), was provided to serve as a dual control for ER localization as well as for ER morphology. ERM consists of the N-terminal 1-27 amino acids of cytochrome P450 2C1 (CYP2C1) (Lam et al., 2015; Sandig et al., 1999). An ERM-APEX2 fusion localizes to the ER membrane such that the APEX2 tag faces the cytosol. Additionally, ERM is known to induce a reorganization of the smooth ER into distinctive ordered membrane structures called organized smooth ER (OSER) (Snapp et al., 2003; Lam et al., 2015; Sandig et al., 1999). Thus, ERM-APEX2 serves as an excellent metric for assessing both ER membrane-specific staining and ultrastructural membrane preservation.

Next, since degradation of the cellular ultrastructure in traditional aldehyde fixation and alcohol dehydration methods appears to be largely associated with the alcohol dehydration post-processing steps and not with aldehyde fixation per se, a combination method proposed by Sosinsky et al. (2008) was utilized, which relies on chemical fixation prior to cryofixation and optimally preserves membrane structure. This combination approach was applied to the detection of APEX2-tagged proteins. Using this methodology, minimal lipid extraction or distortion of membrane structures was observed, and were able to clearly detect ER membrane-bound HYPE.

The hybrid method (cryoAPEX) performed remarkably well for protein localization at the subcellular level. Comparison of ERM-APEX2 in cryoAPEX-treated cells versus live cryofixed (HPF alone) cells showed well-preserved OSER morphology with ER-specific staining only on the cytosolic face of the ER membrane. Further, data collected on cryoAPEX-treated cells could be used to reconstruct a 3D representation of HYPE within the ER lumen. This ability to simultaneously assess the detection of a membrane protein in multiple cellular compartments throughout the subcellular volume of a single cell at low-nanoscale resolution is a significant advance. More broadly, cryoAPEX presents a straightforward methodology for probing the subcellular distribution of membrane-bound proteins, with either lumen-facing or cytosol-facing topologies, that is amenable to high-resolution 3D tomographic reconstruction.

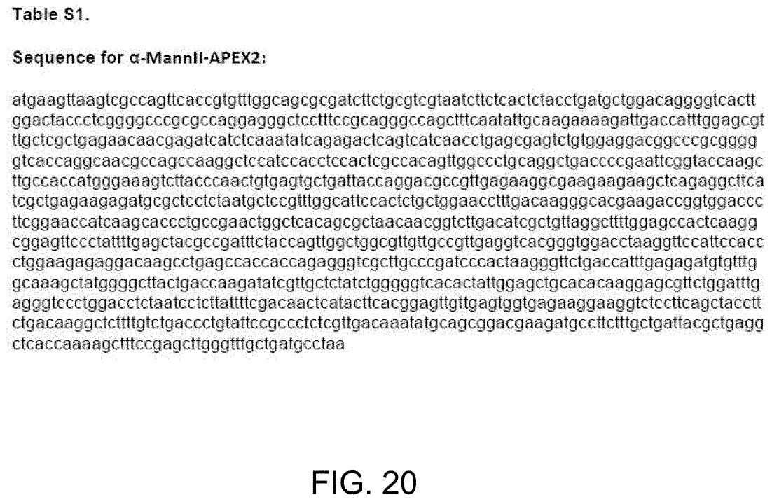

In these investigations, HYPE-APEX2 plasmids were provided and analyzed. HYPE-APEX2 fusion was first synthesized and then inserted into pcDNA3 vector between BamHI and XhoI sites. Briefly, a fusion construct comprising the first 118 amino acids of the mouse isoform of α-mannosidase with the APEX2 gene in its C-terminus following a short intervening linker sequence was first synthesized and then cloned into pcDNA3.1. The complete sequence for MannII-APEX2 is provided (Table S1 in FIG. 20).

Transfection and chemical fixation were performed by growing HEK-293T cells (ATCC) in 10 cm dishes in Dulbecco's modified Eagle's medium (DMEM; Corning) supplemented with 10% fetal bovine serum (FBS; Corning NuSerum IV) at 37° C. and 5% CO₂. Cells were transfected with APEX2-tagged mammalian expression plasmids using Lipofectamine 3000 (Thermo Fisher). Cells were washed off the plate with Dulbecco's PBS 12 to 15 h post-transfection and then pelleted at 500 g. For those samples requiring chemical fixation, pellets were resuspended in 0.1% sodium cacodylate buffer containing 2% glutaraldehyde for 30 min, washed 3 times for 5 min with 0.1% sodium cacodylate buffer and 1 time with cacodylate buffer containing 1 mg/ml 3,3′-diaminobenzidine (DAB) (Sigma-Aldrich). Pellets were then incubated for 30 min in a freshly made solution of 1 mg/ml DAB and 5.88 mM hydrogen peroxide in cacodylate buffer, pelleted and washed 2 times for 5 min in cacodylate buffer and once with DMEM. Finally, cell pellets were resuspended in DMEM containing 10% FBS and 15-20% BSA, then pelleted again. The supernatant was aspirated and excess media wicked off with a Kimwipe in order to remove as much liquid as possible. For BHK (ATCC) controls, cells were grown in DMEM with 10% FBS at 37° C. and 5% CO₂. Cells were either cryofixed directly or prefixed with glutaraldehyde prior to cryofixation. An identical freeze-substitution protocol was used for processing for both HEK-293T and BHK cells. BHK cells were post-stained with uranyl acetate and Sato's lead prior to imaging.

To perform high-pressure freezing and freeze substitution, cell pellets (2 to 3 μl) were loaded onto copper membrane carriers (1 mm×0.5 mm; Ted Pella Inc.) and cryofixed using the EM PACT2 high-pressure freezer (Leica). Cryofixed cells were then processed by freeze substitution using an AFS2 automated freeze substitution unit (Leica). An extended freeze substitution protocol was optimized for the preferential osmication of the peroxidase-DAB byproduct. Briefly, frozen pellets were incubated for 24 h at −90° C. in acetone containing 0.2% tannic acid and then washed 3 times for 5 min with glass-distilled acetone (EM Sciences). Pellets were resuspended in acetone containing 5% water and 1% osmium tetroxide, with or without 2% uranyl acetate (as applicable) for 72 h at −80° C. Following this extended osmication cycle, pellets were warmed to 0° C. over 12 to 18 h. Pellets were then washed 3 times for 30 min with freshly opened glass-distilled acetone. Resin exchange was carried out by infiltrating the sample with a gradually increasing concentration of Durcupan ACM resin (Sigma-Aldrich) as follows: 2%, 4% and 8% for 2 h each and then 15%, 30%, 60%, 90%, 100% and 100% plus component C (Durcupan100+C hereafter) for 4 h each. Resin-infiltrated samples in membrane carriers were then embedded in resin blocks and polymerized at 60° C. for 36 h. Post-hardening, planchets were extracted by dabbing liquid nitrogen on the membrane carriers and using a razor to resect them out of the hardened resin. After extraction of membrane carriers, a thin layer of Durcupan100+C was added on top of the exposed samples and incubated in an oven at 60° C. for 24 to 36 h to obtain the final hardened sample blocks for sectioning.

Sample preparation was performed via a conventional room temperature method. Specifically, HEK-293T cells were grown on collagen-coated glass coverslips and transfected with HYPE-APEX2 or ERM-APEX2 mammalian expression plasmids for 24 h as above. Cells were then washed with DPBS and chemically fixed with 2% glutaraldehyde in 0.1% sodium cacodylate buffer for 30 min. Fixed cells were washed with cacodylate buffer and finally with 1 mg/ml of DAB in cacodylate buffer for 2 min. Following the wash, cells were incubated for 30 min in a freshly made solution of 1 mg/ml of DAB and 5.88 mM of hydrogen peroxide in cacodylate buffer at room temperature. Cells were washed 3 times for 2 min each with DPBS, incubated in an aqueous solution of 1% osmium tetroxide for 10-15 min and then washed with distilled water. Dehydration was carried out using increasing concentration of 200 proof ethanol (30%, 50%, 70%, 90%, 95%, 100%) followed by resin infiltration of the cells with gradually increasing concentrations of Durcupan resin in ethanol (30%, 60%, 90%, 100%), then Durcupan100+C. Coverslips were placed on BEEM capsules filled with Durcupan100+C, cell-face-down on the resin and incubated in an oven for 48 h at 60° C. After polymerization, coverslips were extracted by dipping the coverslip face of the blocks briefly in liquid nitrogen. Serial sections were then obtained by sectioning of the blocks en face and ribbons collected on formvar-coated slot grids.

For serial sectioning, lead staining and electron microcopy, thin (90 nm) serial sections were obtained using a UC7 ultramicrotome (Leica) and collected onto formvar-coated copper slot grids (EMsciences). Glass knives were freshly prepared from glass sticks during each sectioning exercise. Lead staining of the sections was carried out for 1 min wherever applicable with freshly made Sato's lead solution. Samples were screened on a Technai T-12 80 kV transmission electron microscope, and an average of 15-20 cells from multiple blocks were visualized for each sample.

EM tomography, data reconstruction, and segmentation included using thicker (250 nm) sections for collecting tomographic tilt-series. Sections were coated with gold fiducials measuring 20 nm in diameter prior to collection. Tilt-series of a single 250 nm section were collected with automation using the program SerialEM (Mastronarde, 2003) on a JEOL3200 TEM operating at 300 kV. The collected tilt-series were then aligned and tomogram generated by weighted back projection using the eTomointerface of IMOD (Kremer et al., 1996). The reconstructed tomogram was visualized in IMOD. The ER membrane was first hand-segmented and then used as a mask for thresholding of the density within the ER lumen.

In cellular imaging, the ability to obtain 3D spatial localization of proteins in the context of well-preserved cellular structures at high resolution is highly desirable (O'Toole et al., 2018). For antibody-conjugate-based detection methods to be effective, ultrastructure-damaging permeabilization and/or technically challenging ultracryosectioning are required. At EM resolutions, the deleterious effects of such treatments, particularly upon membrane-bound compartments, become obvious. Fusion of a protein of interest to the monomeric enhanced peroxidase APEX2 avoids the need for an antibody. However, the published protocols still use chemical fixation and alcohol dehydration prior to embedding (Martell et al., 2017).

It was hypothesized that the alcohol dehydration step in published APEX2 protocols is limiting for ultrastructural preservation, and consequently for signal intensity and resolution. Therefore, cryofixation-freeze substitution (HPF-FS) of live cells was utilized for preservation, and it was combined with chemical fixation methods to optimize ultrastructural preservation in untransfected human HEK-293T cells.

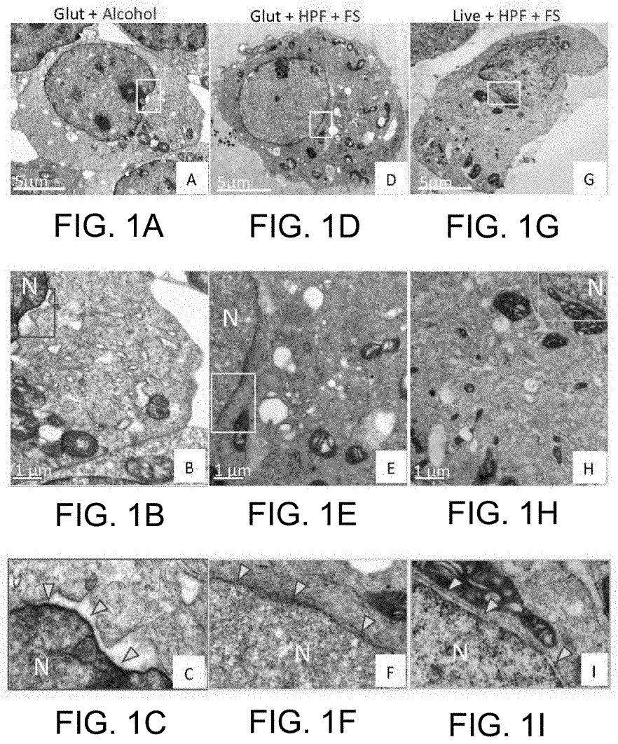

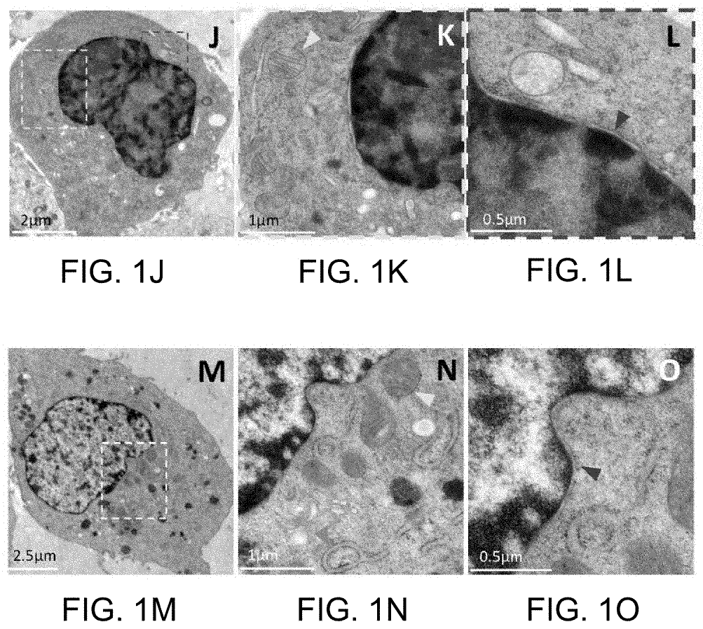

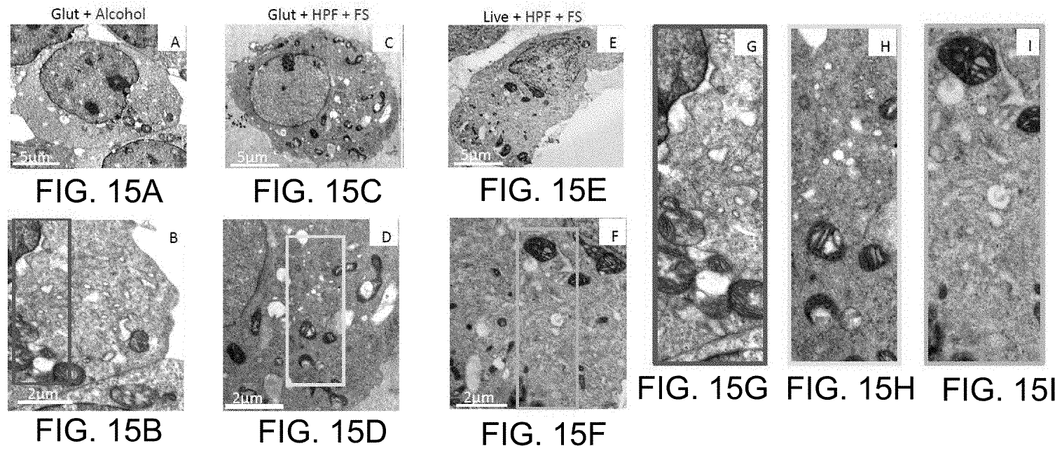

Preservation was assessed based on several criteria including membrane integrity, smoothness of intracellular membranes, densely packed cytoplasm, and maintenance of organellar structures such as mitochondria with clearly visible cristae. Smoothness of intracellular membranes is often a primary indication of good preservation, and preservation of the nuclear envelope has been used classically as a hallmark (Sosinsky et al., 2008; Tsang et al., 2018). As shown in FIGS. 1A-1C, traditionally used glutaraldehyde fixation and alcohol dehydration methods showed poor preservation of the nuclear membrane with intermittent ruffling and separation of the double membrane. The cytoplasm of these cells also appeared less granulated and less densely packed (FIGS. 15A, 15B, and 15G). By contrast, the HPF-FS-processed samples showed excellent preservation of the nuclear envelope, which was smooth and devoid of distortion (FIGS. 1G-1I). Additionally, the cytoplasm was densely packed and the mitochondrial membrane remained intact, with clearly visible cristae (FIGS. 15E, 15F, and 15I). Next, the cell samples were fixed with glutaraldehyde prior to HPF-FS (FIGS. 1D-1F; FIGS. 15C, 15D, and 15H). Morphological damage beyond that seen with HPF-FS alone was minimal, and this combination approach conferred substantially better ultrastructural preservation relative to traditional fixation techniques. This excellent membrane preservation via the combination (Glut+HPF+FS) method was further substantiated when it was extended to another cell line, BHK (baby hamster kidney) cells that are routinely used in electron microscopy studies (Hawes et al., 2007). Indeed, a comparison of ultrastructural preservation using HPF-FS (FIGS. 1J-1L) versus the combination method (FIGS. 1M-1O) showed similar results, as determined by a well-preserved nuclear membrane (red arrowheads), and comparable preservation of mitochondrial (yellow arrowheads) structure and ER (blue arrowheads) membranes.

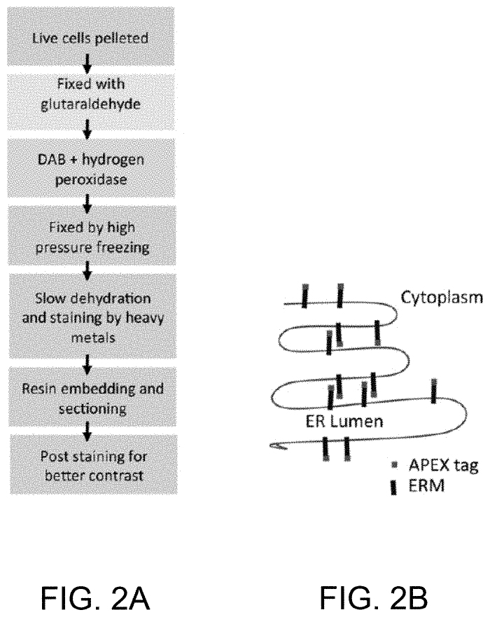

Next, the applicability of the combination method was tested for ultrastructural preservation with the use of the APEX2 tag to follow a protein of interest, creating the hybrid glutaraldehyde+HPF-FS+APEX2 method referred to herein as cryoAPEX (FIG. 2A).

To serve as a proof of concept, cryoAPEX was evaluated by assessing the membrane localization of the ERM-APEX2 chimeric protein (FIG. 2B). Expression of ERM results in ER localization of the peptide as a membrane protein, such that the peroxidase tag faces the cytoplasm (Lam et al., 2015) (FIG. 2B). This topology in the ER membrane serves as an additional control for HYPE, which displays the opposite orientation in the membrane. ERM expression is known to cause reorganization of the smooth ER and increased membrane biogenesis (Lam et al., 2015; Sandig et al., 1999). Cells expressing ERM form OSERs, which are distinctive ordered labile membrane structures that can be easily visualized via electron microscopy without the need for specialized detection methods (Snapp et al., 2003). Thus, it is possible to conveniently assess the degree of membrane preservation in conjunction with various sample preparation methods, providing an excellent metric for assessing both staining specificity and ultrastructural preservation in one system.

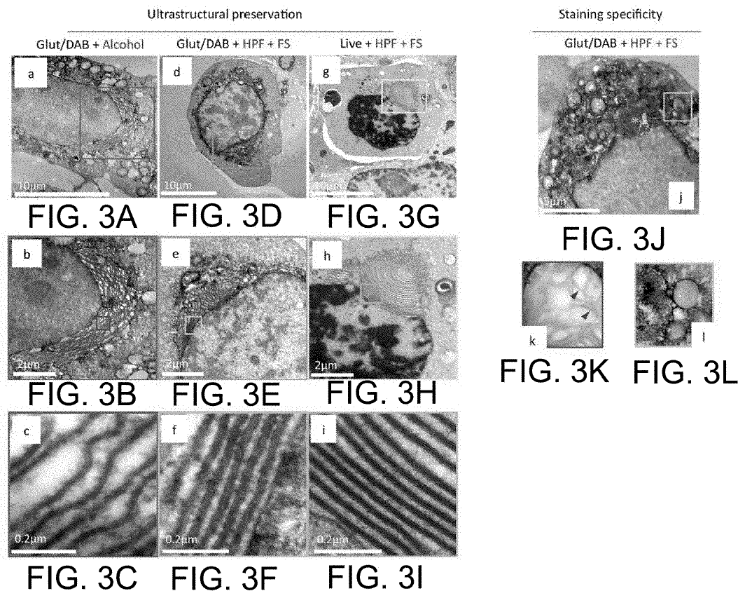

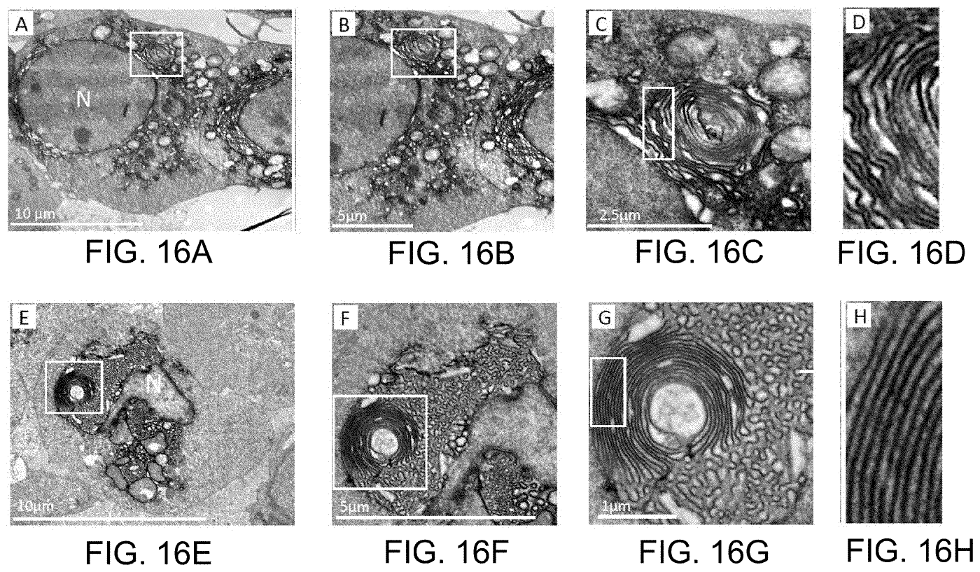

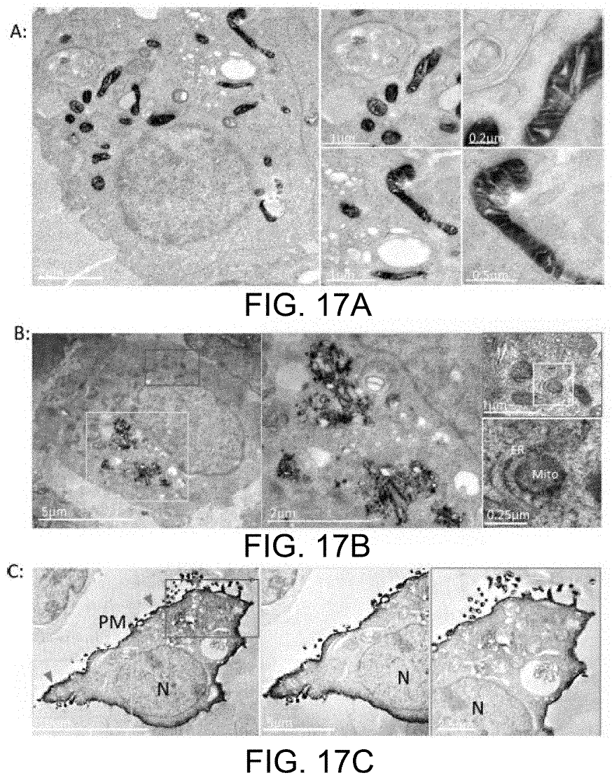

As a morphological control, thin sections of ERM-APEX2-transfected cells were processed using HPF-FS alone and then stained using osmium tetroxide, tannic acid and uranyl acetate but without chemical fixation or the DAB reaction. Under these conditions, the typical membrane whorl pattern of reorganized ER adjacent to the nucleus was clearly visible (FIGS. 3G-3I, yellow and green boxes). OSER membranes within these were arranged in evenly spaced parallel stacks without disruption or ruffling (FIG. 3I). By contrast, traditional methods showed a clear disruption of the lamellar stacking of these OSER structures (FIGS. 3A-3C; FIGS. 16A-16D), with artefactual ruffling of the membrane stacks and presumed loss of cytoplasmic material between the stacks (compare FIG. 3C and FIG. 17D with FIG. 3I). However, the cryoAPEX method (FIGS. 3D-3F; FIGS. 17E-17H) resulted in well-preserved ER-derived lamellar structures comparable to the lamellar stacking in ER-derived structures observed in live HPF-FS controls (compare FIG. 3F and FIG. 17H with FIG. 3I). Peroxidase-reacted samples were also processed in parallel without uranyl acetate, as uranyl acetate stains nucleic acids and therefore the nucleus, and, to some extent, the mitochondria (FIGS. 3J-3L, red asterisks). Tannic acid was also eliminated from these samples to minimize background staining (FIGS. 3J-3L) (Huxley and Zubay, 1961; Kalina and Pease, 1977; Persi and Burnham, 1981; Schrijvers et al., 1989). Staining was not observed within the nucleus (FIG. 3J) or in mitochondrial cristae (FIG. 3K, red arrowheads within red box) but was seen in the ER-derived structures (FIGS. 3K and 3L, yellow asterisks and yellow arrowheads within yellow box). As additional controls for the specificity of the ERM-APEX2 staining for the ER, localization of three organellar markers—namely, mito-V5-APEX2 that targets to the mitochondrial matrix (Addgene plasmid #72480; Lam et al., 2015); CAAX-APEX2 that targets to the plasma membrane (Lam et al., 2015), and ManII-APEX2 that targets to the Golgi lumen were assessed. FIGS. 17A-17C show APEX2-associated staining only at the mitochondria, Golgi, and plasma membrane, respectively, confirming that APEX2-associated signals obtained in our assays are specific to the tagged protein.

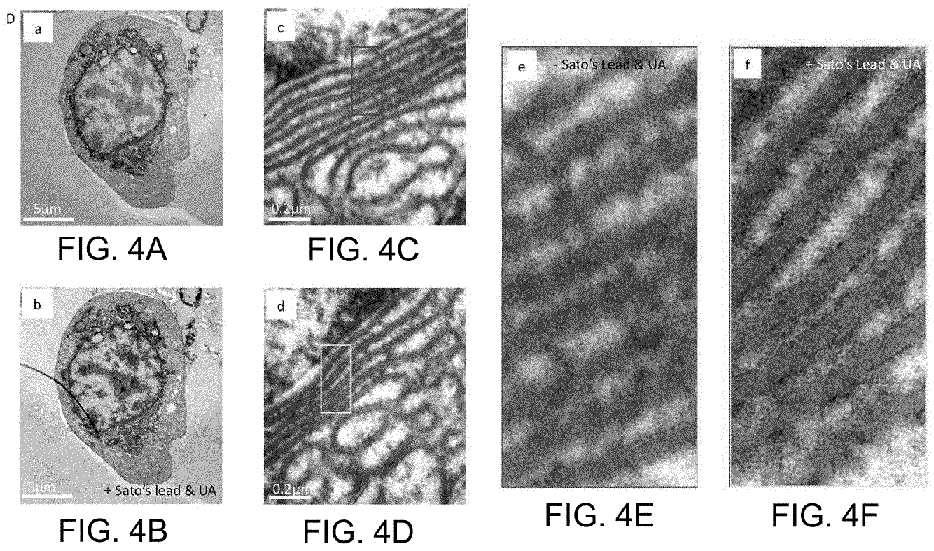

To enhance the contrast of membrane staining over the background of overall osmicated DAB density (i.e. osmiumstained DAB precipitate), the same sections shown in FIGS. 3D-3F were imaged before and after post-staining with Sato's lead solution and uranyl acetate (FIGS. 4A-4F). This resulted in an improved ability to distinguish specific staining of adjacent membranes at higher magnifications (FIGS. 4A-4F, compare 4A, 4C, and 4E with 4B, 4D, and 4F, respectively).

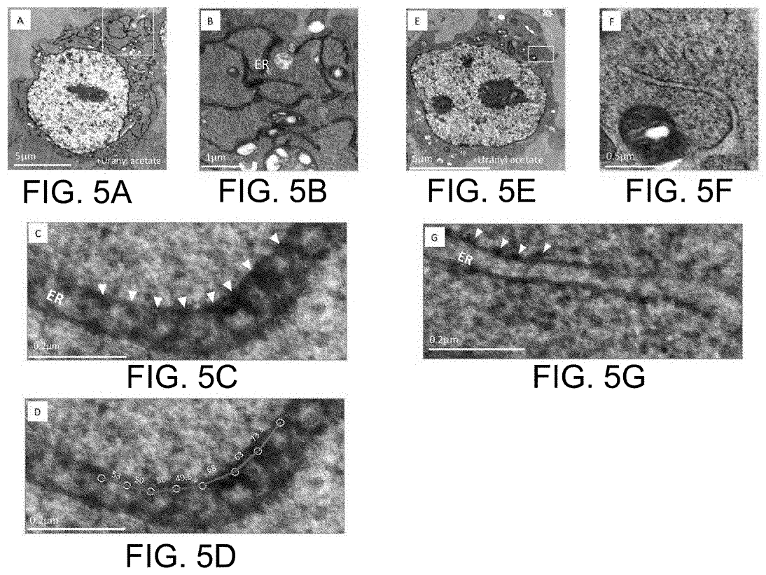

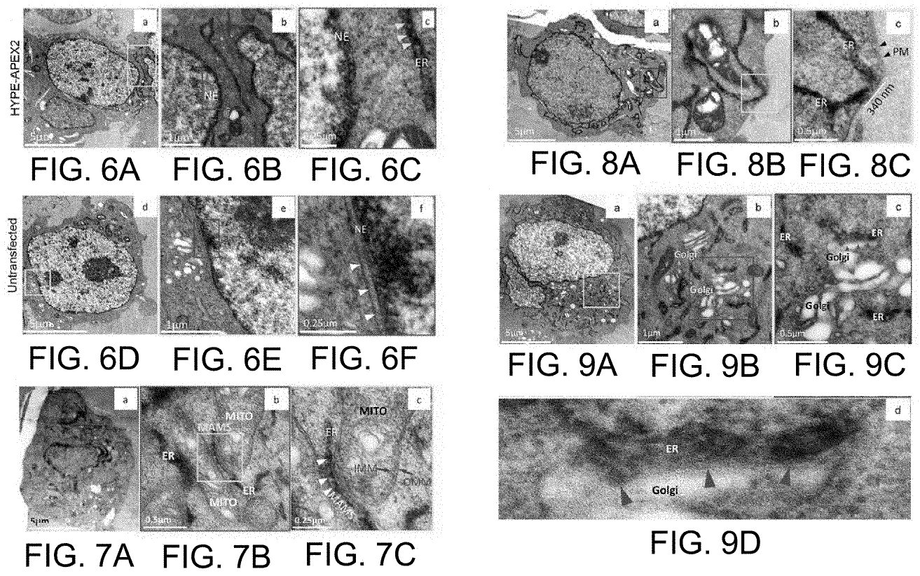

Having established the methodology to localize an APEX2-tagged ER membrane protein in an optimally preserved cell, cryoAPEX was next applied to the sole human FIC protein, HYPE. Previous immunofluorescence, cell fractionation and protease protection assays have placed HYPE as predominantly facing the ER lumen (Sanyal et al., 2015). A smaller fraction of HYPE has also been detected in the cytosol, as well as in the perinuclear space (Truttmann et al., 2015, 2017). Therefore, HEK-293T cells were transiently transfected with HYPE-APEX2 constructs and processed using cryoAPEX as standardized for ERM-APEX2 above. As before, ultrastructure was well preserved and there were minimal signs of lipid extraction or membrane ruffling (FIGS. 5A-5G). Osmicated DAB density was observed within the lumen of peripheral ER tubules (FIGS. 5A and 5B, yellow and red boxes, respectively) but not in identically treated untransfected controls (FIGS. 5E and 5F, yellow and red boxes). Remarkably, at higher magnification this density resolved into distinct foci along the length of the tubules, on the lumenal face of the ER membrane (FIG. 5C, highlighted by white arrowheads). These HYPE-specific foci averaged a distance of 61.45 nm apart (FIG. 5D).

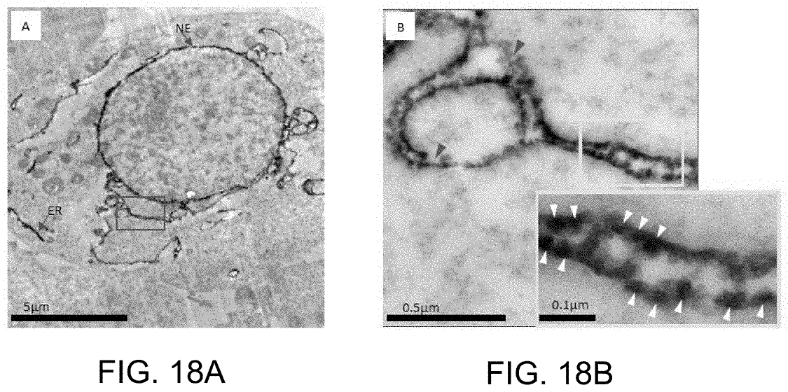

Further, this density was not an artifact of the rough ER, where such density corresponding to the presence of ribosomes is seen only on the cytosolic face of the ER membrane (FIG. 5G). Interestingly, ribosomal density on the outer face of HYPE-APEX2-stained ER membranes was rarely observed. To emphasize the merits of cryoAPEX over traditional methods, HYPE-APEX2-transfected cells were also assessed using the traditional alcohol dehydration method (FIGS. 18A and 18B). Analysis of thin sections using this method revealed a similar staining pattern within the tubules of the peripheral ER and nuclear envelope (FIG. 18B, white arrowheads within yellow box). However, as expected, there was poor preservation of the ER membrane and intermittent regions of membrane discontinuity (FIG. 18B, red arrowheads). Additionally, the presence of other membrane-bound structures was mostly indiscernible (compare FIG. 18A with FIG. 5A), thus making it impossible to get contextual information about the other organelles in the immediate vicinity or in contact with the ER membrane containing HYPE. Clearly, cryoAPEX offers high-resolution localization for HYPE in the ER lumen in the context of other organelles at the subcellular level.

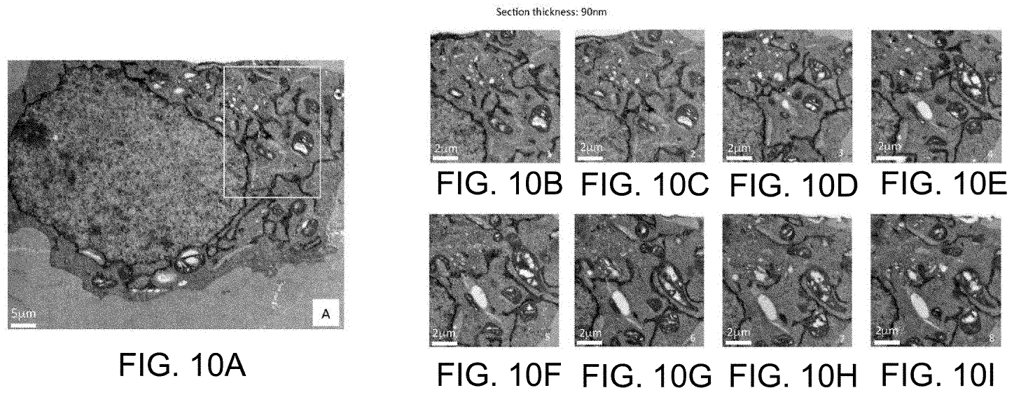

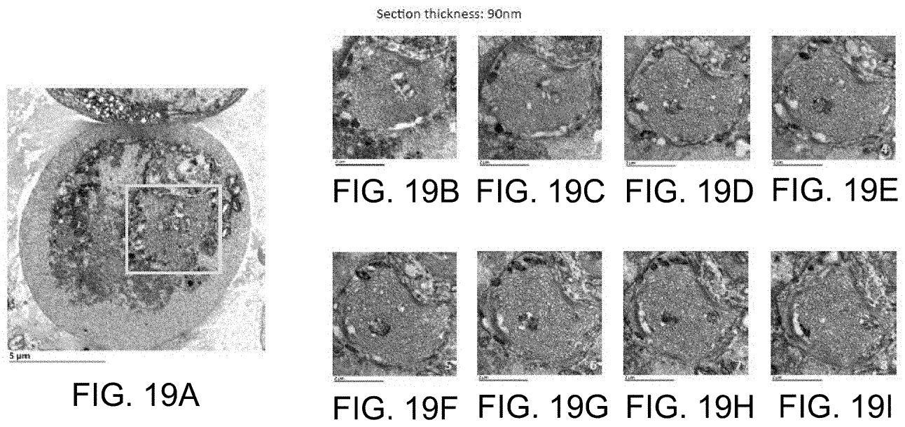

Perhaps the greatest advantage of using cryofixation for sample preparation for EM is its capability to preserve membrane ultrastructure consistently throughout the cell volume. To track the distribution of HYPE over a large subcellular volume, serial section EM was employed (FIGS. 10A-10I). Multiple ribbons containing between 10 and 20 serial sections, each 90 nm thick, were collected and screened. Representative images of a subset of eight serial sections selected from a larger set of images of a demarcated region from a single cell are depicted (FIG. 10A, yellow box and panels numbered 1-8). The images capture a region of a peripheral ER network showing osmicated DAB density within the ER and in close proximity to the mitochondria and Golgi apparatus. The excellent preservation of the ultrastructure of these neighboring organelles and the additional uranyl acetate staining provide contextual information within which HYPE resides. A similar analysis of ERM-APEX2 is shown in FIGS. 19A through 19I. Thus, such preservation and staining using cryoAPEX allows us to subsequently use EM tomography to determine the localization of membrane proteins like HYPE and ERM in 3D.

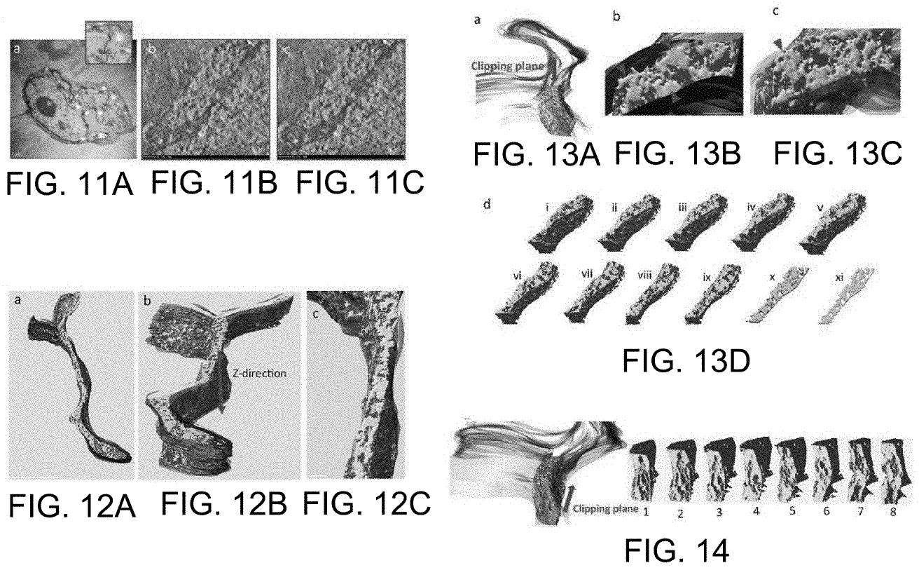

To visualize HYPE, a tilt series from a single 250 nm section of HEK-293T cells expressing HYPE-APEX2 was collected (FIG. 11A). The 3D reconstruction of HYPE within the ER was carried out for the region of the cell demarcated by the red box (FIG. 11A, red box). FIG. 11B represents a single slice from a 3D reconstruction for HYPE density obtained from the tilt series, and a representative single slice. The thresholded density for HYPE (colorized in maroon) is presented as a representative single slice in FIG. 11C. These reconstructions confirm the periodic distribution of HYPE density throughout the lumenal face of the ER membrane.

Next, 3D modeling by segmentation and visualization of the HYPE-APEX2 density showed that HYPE was confined within the ER membrane (FIGS. 12A-12C). This reconstructed segment of the ER was further assessed from different visual perspectives (FIG. 12A, whole ER segment; 6Bb, z plane; and 6Bc, top down). Finally, the ‘clipping planes’ tool from IMOD was used to incrementally trim off the HYPE-associated density from the top to the bottom (moving in the z-direction; FIGS. 13A-13C and slices i-xi in FIG. 13D) and in a head-to-tail direction (FIG. 14, slices 1-8). Both clipping planes substantiated the observations of the periodic foci for HYPE on the lumenal walls of the ER (FIGS. 13B and 13C, red arrowheads). Thinner, virtual slices of this region resembled the density pattern seen in 2D imaging of thin sections (compare FIG. 13D, slice xi with FIG. 5C).

FIC-mediated adenylylation (AMPylation) is an important, evolutionarily conserved mechanism of signal transduction. In humans, AMPylation mediated by HYPE regulates the unfolded protein response via reversible modification of BiP (Ham et al., 2014; Preissler, et al., 2017a,b; Sanyal et al., 2015). It is an open question as to whether HYPE functions beyond its role as a UPR regulator with additional physiological targets. Indeed, despite the fact that it has previously been shown that HYPE is an ER membrane protein that faces the lumen (Sanyal et al., 2015; Rahman et al., 2012), a number of candidate targets have recently emerged for further evaluation that reside outside the ER (Broncel et al., 2016; Truttmann et al., 2016). For instance, the C. elegans homolog of HYPE (FIC-1) can be detected in the cytosol and is implicated in controlling the function of cytosolic chaperones (Truttmann et al., 2017). The Drosophila melanogaster HYPE homolog (dFic) is implicated in blindness and has been shown to associate with cell surface neuro-glial junctions, possibly by entering the secretory pathway (Rahman et al., 2012). Thus, a clear subcellular localization for HYPE is needed to better understand its role in the context of these new protein targets—which led to the development a technique to determine the subcellular localization of membrane proteins like HYPE at a high (low-nanoscale) resolution.

Despite tremendous advances in light microscopy, electron microscopy still remains the technique of choice to visualize cellular ultrastructure or determine protein localization at nanoscale resolution. Here, the development of an EM method, called cryoAPEX, is described which successfully adapts the APEX2 tag for cryofixation while simultaneously retaining membrane preservation. Additionally, it has been evidenced herein that data obtained using cryoAPEX for visualizing ER proteins, HYPE and ERM, can be used for EM tomographic reconstruction of membranes in 3D. Applying cryoAPEX to HYPE localization, it has been shown herein that HYPE appears to reside solely in the ER lumen and in the contiguous nuclear envelope, in agreement with immunofluorescence data from industry (Sanyal et al., 2015; Truttmann et al., 2015).

CryoAPEX is designed specifically for localizing membrane-bound proteins. The methodology presented herein enables sufficient resolution and membrane preservation such that even structures in close contact with the ER, such as the Golgi, mitochondria or plasma membrane, are clearly distinguishable as HYPE-negative (FIGS. 7A-7C, 8A-8C, and 9A-9D).

Many organelles and transport vesicles within a cell are labile structures that are difficult to preserve in their native morphology. An organelle like the ER has multiple domains that make contacts with several other organelles as well as the plasma membrane. The functional relevance of these organellar contact points is of research interest and, in the case of the ER, they are known to be portals of lipid and calcium transport (English and Voeltz, 2013; Rowland and Voeltz, 2012). Thus, preservation of these structures was especially important for ascertaining the distribution of HYPE.

Next, the applicability of various traditional protein localization techniques were considered such as immunoelectron microscopy (IEM), metal-tagging EM (METTEM), and peroxidase tagging. Unfortunately, each of these techniques suffers from a variety of limitations in addition to inadequate sample preservation. Specifically, current methods of detection are based on two common processes: (1) a chemical fixation step that precedes the actual detection assay and (2) a sample preparation step involving dehydration of fixed cells via alcohol at room temperature or on ice. This combination of chemical reagents leads to poor preservation of the membrane morphology as a result of lipid extraction, and introduces artefacts. Therefore, in addition to membrane preservation, the method of choice needs to be compatible with heavy metal staining, so as to impart an adequate level of contrast between HYPE-associated membranes and other organellar membranes for contextual information about the ultrastructural environment within which HYPE resides. This ruled out METTEM tagging, as the technique is incompatible with the use of heavy metal stains (Risco et al., 2012).

Lastly, the amenability of the method to 3D electron microscopic techniques was considered. This is notable as organelles or membrane structures such as the ER, Golgi, mitochondria, or the plasma membrane cover a vast three-dimensional subcellular space and are in a constant state of morphological equilibrium with their surroundings. They undergo constant remodeling in their different domains in response to functional cues that can alter the localization of proteins that are associated with them (Shibata et al., 2010; Voeltz et al., 2002). To detect such changes or, alternatively, the exclusive localization of a target protein in specific domains of these large organelles, 3D information at the site of protein localization can yield critical clues about protein function. Thus, development focused on a method that incorporated each of the above criteria to yield HYPE's subcellular distribution in an optimally preserved and 3D EM-compatible sample.

Cryofixation of live cells under high pressure (HPF) is a method that shows improved ultrastructural preservation and is now routinely used to prepare samples for EM tomography (McDonald and Auer, 2006; O'Toole et al., 2018). It is not deemed compatible with most of the detection methods described above, however, as they require chemical fixation. Thus, to determine the subcellular distribution of HYPE, cryoAPEX was developed, a hybrid method that combines the power of APEX2 genetic tagging and HPF cryofixation. Chemically fixed cells expressing APEX2-tagged HYPE were first reacted with DAB to generate HYPE-specific density, and then cryofixed and freeze-substituted with acetone. As shown, cryoAPEX not only displays specificity of detection at high resolution for both lumen-facing (HYPE) and cytosol-facing (ERM) ER membrane proteins, but also retains ultrastructural preservation that makes cryoAPEX amenable to TEM tomography. Further, cryoAPEX can be used to assess cells grown in monolayers, making it widely applicable.

A notable aspect of cryoAPEX is the robustness of the DAB byproduct that can withstand a long freeze-substitution reaction in acetone. It was observed that once chemically fixed and labeled with DAB, cells do not need to be cryofixed right away. For example, aldehyde-fixed, DAB-labeled cells that were cryofixed after 48 h (storage at 4° C.) exhibited no deterioration of cellular ultrastructure and staining when compared to those that were cryofixed immediately. This feature could prove to be of great advantage to laboratories that do not have immediate access to HPF and freeze substitution units.

In conclusion, cryoAPEX has been shown to be a method for obtaining localization of a single APEX2-tagged protein at a high resolution while maintaining excellent ultrastructural preservation and compatibility with EM tomography. CryoAPEX was applied to assess the subcellular localization of the human FIC protein, HYPE, and show that it is robustly detected very specifically on the lumenal face of the ER membrane and in cellular compartments that are contiguous with the ER lumen, where it displays periodic distribution resembling possible signaling complexes. Further, HYPE was not detected in the mitochondria, nucleus, plasma membrane, or the Golgi and secretory network at the expression levels tested. Additionally, it was shown that cryoAPEX works equally well for cytosol-facing membrane proteins, such as ERM, and accurately reflects ultrastructural morphological changes. Finally, it was demonstrated that cryoAPEX can be applied to assessing protein localization using cell monolayers and executed in basic cell biology laboratories with relative ease.

While the invention has been described in terms of specific or particular embodiments and investigations, it should be apparent that alternatives could be adopted by one skilled in the art. For example, process parameters such as temperatures and durations could be modified, and appropriate materials could be substituted for those noted. Accordingly, it should be understood that the invention is not necessarily limited to any embodiment described herein. It should also be understood that the phraseology and terminology employed above are for the purpose of describing the disclosed embodiments and investigations, and do not necessarily serve as limitations to the scope of the invention. Therefore, the scope of the invention is to be limited only by the following claims.

1. A method of preparing live cells for analysis, the method comprising:
performing a chemical fixation process on a cellular sample comprising the live cells; and then
performing a cryofixation process with extended osmication during freeze substitution on the cellular sample.

2. The method of claim 1, wherein the chemical fixation process includes a glutaraldehyde fixation process.

3. The method of claim 1, further comprising performing a peroxidase tagging process on the cellular sample.

4. The method of claim 1, further comprising performing a staining process on the cellular sample.

5. The method of claim 3, wherein the cell sample is stained with tannic acid.

6. The method of claim 3, wherein the cell sample is stained with uranyl acetate.

7. The method of claim 3, wherein the cell sample is counter-stained with a lead solution.

8. The method of claim 1, further comprising analyzing the cell sample with electron tomography.

9. The method of claim 8, further comprising determining localization of membrane-bound proteins within a preserved membrane architecture within the cellular sample.

10. The method of claim 9, wherein the membrane-bound proteins are luminal or cytosol-facing membrane proteins.

11. The method of claim 10, wherein the membrane-bound protein is human FIC (filamentation induced by cAMP) protein (HYPE).

12. The method of claim 8, further comprising producing a three-dimensional contextual map of the cell sample.

13. The method of claim 1, wherein the cellular sample comprises cells grown in monolayers.

14. The method of claim 1, further comprising reacting the cellular sample with diaminobenzadine (DAB).

15. The method of claim 1, wherein the method does not include a dehydration step prior to performing the cryofixation process.

16. A method for determining localization of membrane-bound proteins within a preserved membrane architecture within a cellular sample, the method comprising:
performing a glutaraldehyde fixation process on a cellular sample comprising the live cells;
performing a cryofixation process with extended osmication during freeze substitution on the cellular sample;
performing a staining process on the cellular sample; and
analyzing the cell sample with electron tomography.

17. The method of claim 16, wherein the cell sample is stained with tannic acid.

18. The method of claim 16, wherein the cell sample is stained with uranyl acetate.

19. The method of claim 16, wherein the cell sample is counter-stained with a lead solution.

20. The method of claim 16, further comprising producing a three-dimensional contextual map of the cell sample.


SEQUENCE LISTING (1 sequence)

SEQ ID NO: 1 - DNA, 1113 bp, Artificial Sequence
  Description of Artificial Sequence Synthetic polynucleotide
atgaagttaagtcgccagttcaccgtgtttggcagcgcgatcttctgcgtcgtaatcttctcactctacctgatgctggacaggggtcacttggactaccctcggggcccgcgccaggagggctcctttccgcagggccagctttcaatattgcaagaaaagattgaccatttggagcgtttgctcgctgagaacaacgagatcatctcaaatatcagagactcagtcatcaacctgagcgagtctgtggaggacggcccgcgggggtcaccaggcaacgccagccaaggctccatccacctccactcgccacagttggccctgcaggctgaccccgaattcggtaccaagcttgccaccatgggaaagtcttacccaactgtgagtgctgattaccaggacgccgttgagaaggcgaagaagaagctcagaggcttcatcgctgagaagagatgcgctcctctaatgctccgtttggcattccactctgctggaacctttgacaagggcacgaagaccggtggacccttcggaaccatcaagcaccctgccgaactggctcacagcgctaacaacggtcttgacatcgctgttaggcttttggagccactcaaggcggagttccctattttgagctacgccgatttctaccagttggctggcgttgttgccgttgaggtcacgggtggacctaaggttccattccaccctggaagagaggacaagcctgagccaccaccagagggtcgcttgcccgatcccactaagggttctgaccatttgagagatgtgtttggcaaagctatggggcttactgaccaagatatcgttgctctatctgggggtcacactattggagctgcacacaaggagcgttctggatttgagggtccctggacctctaatcctcttattttcgacaactcatacttcacggagttgttgagtggtgagaaggaaggtctccttcagctaccttctgacaaggctcttttgtctgaccctgtattccgccctctcgttgacaaatatgcagcggacgaagatgccttctttgctgattacgctgaggctcaccaaaagctttccgagcttgggtttgctgatgcctaa